(19) United States
(12) Patent Application Publication
(10) Pub. No.: US 2012/0077151 A1
(43) Pub. Date: Mar. 29, 2012

(54) Morse Taper Dental Implant

(76) Inventors: Hugo Nary Filho, Bauru-SP (BR); Hiron Andreaza Da Cunha, Goiania-GO (BR)

(21) Appl. No.: 12/915,843

(22) Filed: Oct. 29, 2010

(30) Foreign Application Priority Data
Sep. 24, 2010 (BR) 018100035799

(51) Int. Cl. A61C 8/00

(52) U.S. Cl. 433/174

(57) ABSTRACT

A morse taper dental implant with possibility for adaptation of components directly on the implant platform, the implant is a morse taper implant with grooves, which together with the surface treatment, promote adhesion of bone tissue to the implant, and further on the outside details, the implant has a platform switch, i.e. a notch at the top of the implant, leaving the same basis of settlement in whatever the outside diameter of the implant, thus allowing an adjustment of the components directly on the base of the implant (implant level), through the adaptation of the components through the morse taper that reaches heights exceeding 1 mm.

### FIELD OF THE INVENTION

The present application is in the field of dental implants and dental implant platforms.

### BACKGROUND OF THE INVENTION

The dental implant, associated with its accessories, was developed in order to restore lost teeth, in order to restore the chewing function and esthetics of the patient implanted, eliminating therefore the need for prosthetics (dentures). Dental implants can be used in different scenarios of teeth loss, and may trigger a need to use one or more implants.

Integrable bone implant: surgically implanted directly into the jawbone. Once the gum covering it is healed, a second surgery is needed to expose the implant to the oral environment and connect an abutment to the implant. Finally, an artificial tooth (or teeth) is attached to the pillar, individually or grouped in a fixed prosthesis or removable prosthesis (Overdenture).

In cases of loss of a single tooth, after evaluating the individual case, a dental implant is installed, when and initial satisfactory stability allows installing a temporary prosthesis with immediate loading. Subsequently the prosthesis is replaced by a ceramic crown or resin, concluding the dental implant.

When immediate loading is not possible, a temporary prosthesis is installed, which can be fixed or supported on the adjacent teeth with a removable prosthesis supported by the gums. This prosthesis is used during the waiting period for osseointegration to occur.

In order to the installed tooth to have a semblance of natural teeth, it is important that the dental implant is well positioned and that the gums are healthy.

When a patient loses a small group of teeth the greatest advantages of dental implants are the preserving the integrity of neighboring teeth, thus eliminating the need for the use of removable partial dentures.

Dental implants properly installed allow the creation of prostheses that closely resemble natural teeth, and for this to occur, it is important not to have a lot of bone loss. In such cases, to restore the teeth with the dental prosthesis of correct sizes is important for bone grafts are used.

Patients wearing total removable prostheses, the so-called dentures, may benefit from the treatment of dental implants, by replacing the dentures with fixed prostheses supported by dental implants. Dentures for the upper or lower sides can use the technique of immediate loading.

Dental implants are installed and the dental prosthesis is placed on the same day, next day or up to six months of placement.

In cases where there is already a great loss of bone, the graft is made of a lighter material and has teeth attached to a resin structure that mimics the pink color of the gums, and it is called hybrid prosthesis. This new prosthesis is made and screwed to the implants.

This treatment is implemented in a faster way and at lower costs. If the patient has a favorable bone density, the amount of dental implants to be installed may be equal to the number of teeth, and with size and shape of the natural teeth. The teeth are individual, separated and coming out from inside the gums.

Teeth loss is a problem that affects millions of people around the world. Has a direct relationship with chewing disorders, gastrointestinal, facial aging, and undermines the social relationship. As a consequence, there are functional and aesthetic changes. The self-esteem is also lowered.

Dental implants represent an ideal option for those looking to replace some or even all teeth. The surgery is done through the placement of titanium pins, to replace tooth roots. The technique of dental implant provides excellent aesthetic and chewing results and researches indicates that more than 500,000 dental implants are performed annually worldwide, and that success rates are approximately 95% to 98%. For patients who have good bone density, it is now possible to make dental implants with immediate loading. In these cases the implant is placed, and the prosthesis can be installed immediately.

For being integrated into the bone, the implants provide stable support for artificial teeth. Dentures and bridges mounted to implants will not slip or shift in one's mouth, an important benefit when eating and speaking. This secure fit helps the dentures and bridges, as well as individual crowns placed over implants that provide a more natural situation than conventional bridges or dentures.

For some people, ordinary bridges and dentures are simply not comfortable or even not suitable, due to sore spots, poor ridges apices. In addition, ordinary bridges must be attached to teeth on both sides of the space left by the missing tooth. An advantage of implants is that it is not necessary to prepare or wear a natural tooth to support the new replacement teeth in place. To receive implants, the patient is required to have healthy gums and an adequate bone to support it.

The document MU8800606-9 (BR) of 17 Jun. 2008 entitled “IMPROVEMENT INTRODUCED IN MORSE TAPER MINI-PILLAR” is a morse taper Mini-Pillar endowed with a peculiar connection for having a technology that allows the morse taper connection with the conical cavity of a dental implant.

The document P10802042-6 (BR) of 30 Apr. 2008 entitled “DENTAL IMPLANT WITH INTERNAL CONNECTION AND MORSE TAPER WALLS WITH THICK PLATFORM, SHALLOW SCREW IN THE CERVICAL AND DEEP IN THE ⅔ APICAL” is a dental implant, dental implant platform also called the inner platform, hexagon inside the inner platform, taper region inside the platform, shallow region in the apical portion of the screws of the implant, rounded region at the coronal portion of the screws of the implant.

The document MU8801468-1 (BR) of 10 Apr. 2008 entitled “DISPOSITION APPLIED IN DENTAL IMPLANT” is a setting applied to morse/tape-type dental implants inserted in the technical field of implantology of elliptical geometry of the cavity cross-section

MU 8700304-0 (BR) of 5 Mar. 2007 entitled “IMPROVEMENT INTRODUCED IN ZYGOMATIC IMPLANT, PROVIDED WITH INTERNAL CONNECTION THROUGH TAPER-SHAPED CAVITY (MORSE TAPER) FOR ADJUSTMENT AND FIXING OF PROSTHETIC COMPONENTS” is a zygomatic dental implant used frequently in exercises of implantology, which is characterized by being a zygomatic implant provided with a morse taper system that refers to an internal connection through a taper-shaped cavity and has a triangular thread profile and cameras at the apical portion of the implant.

The development of morse taper-type implants prevents loosening of prosthetic screws, which is a critical clinical problem discussed by many researchers, and the loosening is the mismatch between the implant and prosthetic components, directly affecting the tissues around implants and the success of the treatment. The causes of loosening of the prosthetic screws are associated with biomechanical problems, inadequate planning, excessive occlusal forces and insufficient tightening of the screw. Thus, the morse taper fitting was a proposal to solve the problem presented above, improving the stability of the anti-rotational abutment and eliminate bacterial contamination. The attachment between the prosthetic component and the cone of the implant occurs by the friction between the two different surfaces combined with the pressure created by the insertion force.

Implant system with morse taper provides biomechanical advantages, a periodontal advantage regarding the microbiological aspect, prosthetic advantage by ensuring better stability of the component, improvement in the biological aspect to reduce bone loss, has a better mechanical stability and fixation of the prosthesis, reduces rotational movement, has a higher resistance to screw loosening, reduces the clearance between the implant and the middle pillar, improving the junction and the implant abutment bacterial seal and ensures it has expanded the platform in relation to the prosthetic component and reduces saucerization, the tissue formed around implants has similarities with the gum, has less marginal bone loss and ensures the optimization of immediate load for aesthetic cases.

However, this system also has some disadvantages like the fact that it demands greater accuracy in the preparation of the surgical bed, larger surgical care, and there is less versatility with respect to prosthetic implants with external hexagon.

Since its introduction to the concept of osseointegration, dental implants have become a viable treatment option for edentulous patients. The success of an implant depends largely on a balance between biological and mechanical factors. The biological factors are generally multifunctional, since the mechanics are associated with instability of the connection of the intermediate prosthetic implant-screw.

The misfit between the prosthetic component and the implant platform can lead to treatment failure, mainly due to induction of stress concentration, infiltration of bacteria and biofilm formation.

There are three kinds of platforms. The platform with external hexagon, as the older system, has longitudinal studies of greater reliability. As for bacterial infiltration, there is evidence that they always occur even with the implant-abutment gap or reduced with the system with morse taper. Regarding bone absorption, there is possibility of this to occur in any implant system and among all the explanations, the most accepted is because of biomechanical problems.

The present patent application for utility model in the heading title and description object and claim hereof is a scalable solution in the concept of constructive of Morse Taper-type dental implant, mainly used in dental implant procedures in the maxilla and mandible providing means for prosthetic fitting in single-tooth restorations and in partially or fully edentulous sequences using immediate or delayed loading with or without intermediate pillar for making fixed or removable prosthesis.

The new constructive disposition of the above title has been developed having as a paradigm restrictive aspects of functionality provided by the “Morse taper implants” known in the prior art, converging to the scalable solution that lies in improvements in the explicit structure of the object and also in functionality.

### SUMMARY OF THE INVENTION

The present application seeks to provide a morse tapered dental implant comprising a single cylindrical tapered body (2), having (1) an external surface having an upper section and a lower section, wherein the upper section has a side surface and a top surface; the side surface having grooves (3) and the top surface having a rounded platform switch (4); wherein the lower section is a twin screw having a lower tapered end having a bottom part, the bottom part has a bevel (5) having lateral cuts (6) and (7) in an angle following a curvature of an apex (8) of the twin screw (9), and (2) an internal structure adjacent to the top surface and occupying half the internal length of the implant and the internal structure defining an upper cavity (33), defining an hexagon (30) and having a cylindrical internal screw (31); the internal structure fixed to the implant by the cylindrical internal screw (31).

The present application also seeks to provide a morse tapered dental implant comprising a single cylindrical tapered body (2), having (1) an external surface having an upper section and a lower section, wherein the upper section has a side surface and a top surface; the side surface having grooves (3) and the top surface having a platform switch (4); wherein the lower section is a twin screw having a lower tapered end having a bottom part, and has a cutter (10) adjacent to the bottom part with an upward angle constructed and arranged to cross the twin screw (9) along the tapered end and following a curvature of an apex (8) of the twin screw (9), and (2) an internal structure adjacent to the top surface and occupying half the internal length of the implant and the internal structure defining an upper cavity (33), defining an hexagon (30) and having a cylindrical internal screw (31); the internal structure fixed to the implant by the cylindrical internal screw (31).

### BRIEF DESCRIPTION OF THE DRAWINGS

FIG. 1 is a front view of a first embodiment of the morse tapered dental implant.

FIG. 2 is a front view of a second embodiment of the morse tapered dental implant.

FIG. 3 is a front internal view of the morse tapered dental implant.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

The platform of integrable bone implants is on the cervical region of the implant that receives the seating of the prosthetic component. This part of the implant is critical, since it influences the transmission mode of occlusal forces to the bone. The misfit between the prosthetic component and the platform of the implant can lead to the treatment failure, mainly due to induction of stress concentration, infiltration of bacteria and biofilm formation. There are basically two types of platforms, with an external hexagonal and with internal connection. The system varies with internal fitting, one of them being morse the taper.

The platform of the implants with external hexagon facilitates the insertion of implants, and are also extremely important for the fixation of prosthetic components, however, external hexagons present some complications, mentioning the possibility to become deformed during insertion of the implant, need to have a dimensional precision to ensure the engagement of the prosthetic component without excessive clearances, ability to induce stress concentration in the crown as a misfit function and the implant-component facilitates the adhesion of biofilm on the platform edge of the implant with induction of saucerization. The precision of the dimensions of the hexagon is essential to ensure the stability of the prosthesis, minimize the loosening of the prosthetic screw, allow the proper seating of the prosthesis, do not create the vertical and horizontal adjustment of the middle pillar on the platform of the implant and prevent the entry of bacteria into the inner implant hole.

Thus, the applicant presents a solution to the problems cited with the present invention improving with changes in the shape of the implants, such as the development of implants with hexagon-shaped and morse/taper-shaped internal connections.

The exterior design should maintain the same measures of internal and external hexagon implants of the biometry, both for implant with diameters of 3.25, 4.0 and 5.0 mm, using the surgical kit system. The difference at this point will be the use of twin screw for easy insertion of the implant to the bone.

In the upper section of the implant there are grooves, which together with the surface treatment, promote adhesion of the bone tissue to the implant. Further, on the outside details, the implant has a platform switch, i.e. a notch at the top of the implant, leaving the same basis of settlement in whatever the outside diameter of the implant, thus allowing an adjustment of the components directly on the base of the implant (implant level), through the adaptation of the components through the morse taper that reach heights exceeding 1 mm.

Distancing the gap of the implant in contact with the bone tissue, preventing bone loss, which is caused by the inflammatory infiltrate, when one makes contact with the bone gap.

The Morse Taper prosthetic components when connected to the Morse Taper implants have a lower internal space (GAP) when compared to the external or internal hexagonal implants, best sealing, consequently fewer bacteria are housed in the GAP, less inflammatory infiltrate, greater prosthetic retention and stability and less bone loss around the implants, maintaining much of the gums around the implants.

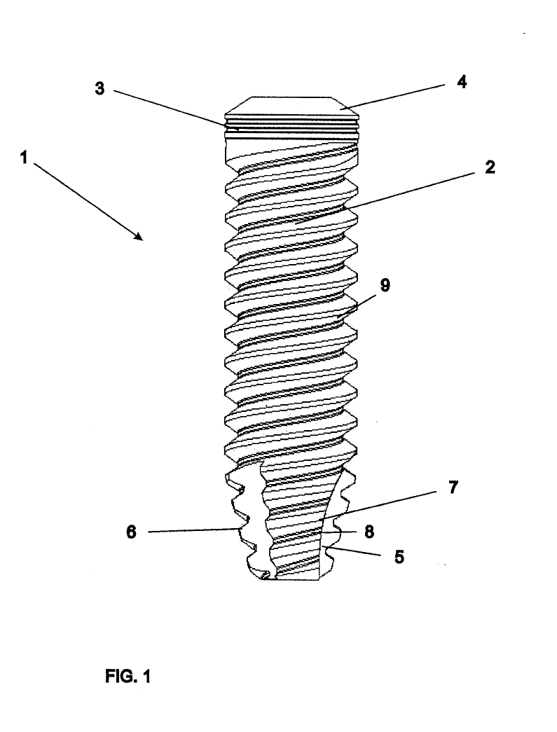

FIG. 1 shows a morse taper implant (1) consisting of a single cylindrical and tapered body (2), and an upper section having grooves (3), in order to improve adhesion of bone tissue. The implant has surface treatment to the top of the implant; the top surface of the upper section is a rounded platform switch (4). On the lower section the implant has bevel (5) (on the base of the implant) with the same angle for all measurements to allow the parts to adapt on it or with changes only on the morse taper of the implant.

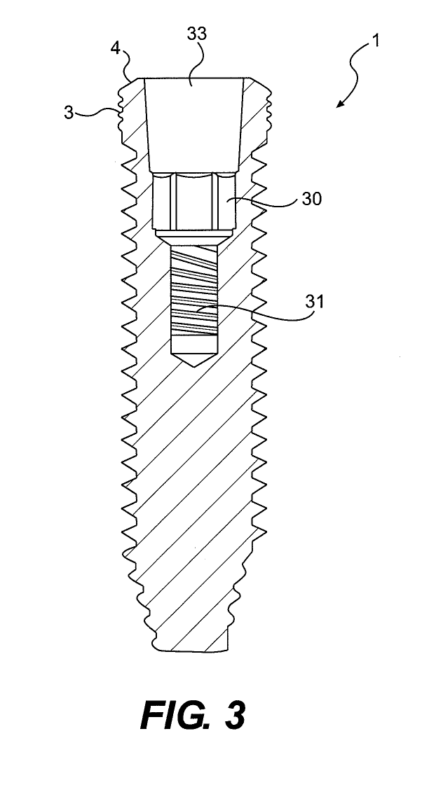

FIG. 3 shows the internal structure of the morse taper (1) defining a hexagon (30), which occupies half the internal length of the implant and through where a cylindrical structured screw (31) extends for fixing the hexagon (30) in the morse tapered implant (1) by the screw. The internal structure is adjacent to the top surface and occupies half the internal length of the implant and the internal structure defines an upper cavity (33), defining a hexagon (30) and having a cylindrical internal screw (31); the internal structure fixed to the implant by the cylindrical internal screw (31).

Hexagon (30) below the morse taper (1), features a more versatile implant, which is used to insert the implant into the bone avoiding the implant mount, and also serves as the guideline of prosthetic components. The implant can be placed on the bone level and below the bone crest.

In FIG. 1, bevel (5) shows lateral cuts (6) and (7) in angle that follows and accompany a curvature of an apex (8) of a twin screw (9) present in the implant body (1).

Cylinder morse taper implant (1) have twin screw (9) and an apex (8) tapered for an easy insertion while maintaining the same surface, the same measurements of external diameter and lengths.

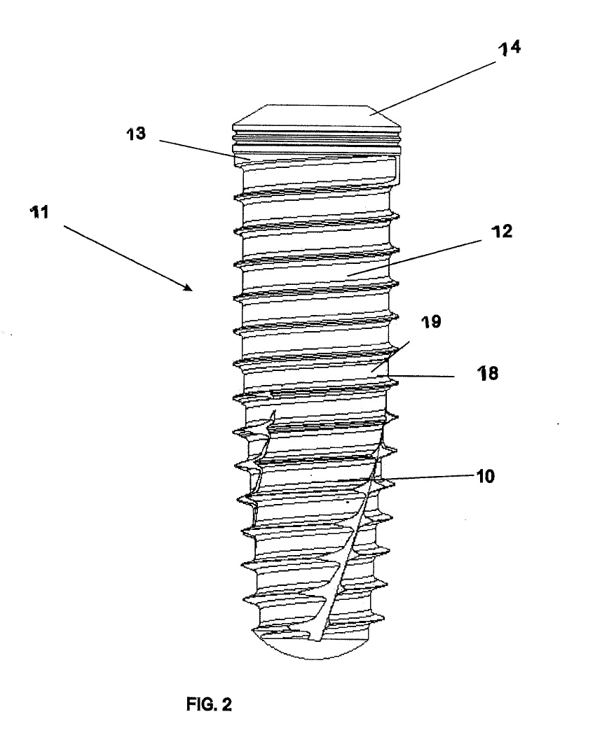

On a second embodiment shown in FIG. 2, the morse taper implant (11) consisted of a single cylindrical and tapered body (12), an upper section having grooves (13), in order to improve adhesion of the bone tissue. The implant has surface treatment to the top of the implant, the top surface of the upper section is a platform switch (14), cutter (10) that parts from the lower section (base) of the implant (11) with the upward angle in order to cross a twin screw (19) present in the tapered cylindrical body of the implant (11).

Morse taper implant (11) has twin screw (19) and an apex (18) tapered for easy insertion, while maintaining the same surface, the same measurements of external diameter and lengths and a cutter (10). The curvature forms an apex (18) on the edge of the twin screw (19).

Having thus described the invention, what is claimed as new and secured by Letters Patent is:

1. A morse tapered dental implant comprising a single cylindrical tapered body, the body having:
(1) an external surface having an upper section and a lower section,
wherein the upper section has a side surface and a top surface; the side surface having grooves and the top surface having a rounded platform switch, and
wherein the lower section is a twin screw having a lower tapered end having a bottom part, the bottom part has a bevel having lateral cuts and in an angle following a curvature of an apex of the twin screw, and
(2) an internal structure adjacent to the top surface and occupying half the internal length of the implant and the internal structure defining an upper cavity, defining an hexagon and having a cylindrical internal screw; the internal structure fixed to the implant by the cylindrical internal screw.

2. A morse tapered dental implant comprising a single cylindrical tapered body, the body having:
(1) an external surface having an upper section and a lower section,
wherein the upper section has a side surface and a top surface; the side surface having grooves and the top surface having a platform switch, and
wherein the lower section is a twin screw having a lower tapered end having a bottom part, and has a cutter adjacent to the bottom part with an upward angle constructed and arranged to cross the twin screw along the tapered end and following a curvature of an apex of the twin screw, and
(2) an internal structure adjacent to the top surface and occupying half the internal length of the implant and the internal structure defining an upper cavity, defining an hexagon and having a cylindrical internal screw; the internal structure fixed to the implant by the cylindrical internal screw.
